(19) United States
(12) Patent Application Publication
(10) Pub. No.: US 2009/0113093 A1
(43) Pub. Date: Apr. 30, 2009

(54) MOBILE STORAGE DEVICE

(75) Inventor: Mike Chen, Arcadia, CA (US)

Correspondence Address: Mike Chen, P.O.BOX 108-00403, Taipei, 106, omitted

(73) Assignee: Mike Chen, Arcadia, CA (US)

(21) Appl. No.: 11/926,141

(22) Filed: Oct. 29, 2007

(51) Int. Cl. G06F 13/00; H01R 31/00; G08B 21/00

(52) U.S. Cl. 710/74; 439/638; 340/636.2

(57) ABSTRACT

A mobile storage device is disclosed to include a connection interface connectable to an external electronic apparatus, an adapter interface for the connection of a mobile electronic device, a data storage device formed of a CPU, a charging unit, a voltage converter, a power indicator unit, a signal switch, a memory and a control chip. By means of the control of the CPU and the control of the signal switch and the control chip, storage data is transferable between the external electronic apparatus and the mobile electronic device or between the external electronic apparatus and the memory of the data storage device, and the battery of the charging unit or the battery of the mobile electronic device is chargeable by the external electronic apparatus.

### BACKGROUND OF THE INVENTION

1. Field of the Invention

The present invention relates to data storage devices and more particularly, to a mobile storage device connectable between an external electronic apparatus and a mobile electronic device for transmission of storage data between the external electronic apparatus and the mobile storage device or between the external electronic apparatus and the memory of the mobile storage device and for charging of the battery of the mobile storage device or the battery of the mobile electronic device by the external electronic apparatus.

2. Description of the Related Art

Following fast development of electronic technology, many advanced digital electronic products are created and used in our daily life to improve the working efficiency and the living quality. Nowadays, people in all fields use desk computers or notebook computers every day. In consequence, many computer compatible peripheral devices such as photo printer, digital camera, digital video camera and etc., are continuously created. These computer compatible peripheral devices commonly have storage means for storing data. The storage means can be a memory card, memory stick, MP3 (MPGE Audio Layer III)/MP4 (MPGE Audio Layer IV) data storage device, mobile hard disk or the like. The capacity of a data storage device can be 128 M, 256 M, 2 G, 4 G, 20 G or even 80 G. A data storage device must be started with electricity before reading or writing data. Further, a mobile electronic device generally uses a battery to provide the necessary working voltage. The battery can be a dry cell, Li-battery or rechargeable battery. When the power of the battery of a mobile electronic device is low, the battery must be charged or replaced with a new one. When charging the battery of a mobile electronic device, a battery charger, power cable, or power adapter may be required. Therefore, using conventional mobile electronic devices may encounter the following problems:

1. Different cables, connectors or adapters may be necessary to fit different mobile electronic devices. It is inconvenient to carry or install different cables, connectors or adapters.

2. For transmission of data between electronic devices or charging different electronic devices, different cables or battery chargers may be necessary.

3. A control host must be equipped with different connectors (USB, RS232, IEEE 1394, PS2, etc.) for the connection of different electronic devices. For the connection of a particular connector, an adapter or hub may be necessary.

Therefore, it is desirable to provide a measure or apparatus that overcome the aforesaid problems.

### SUMMARY OF THE INVENTION

The present invention has been accomplished under the circumstances in view. It is the main object of the present invention to provide a mobile storage device, which is connectable between the external electronic apparatus and the mobile electronic device for data transmission and battery charging.

To achieve this and other objects of the present invention, the mobile storage device is comprised of a data storage device, a connection interface electrically connectable to an external electronic apparatus, and an adapter interface. The data storage device comprises a central processing unit, a charging unit electrically connected to the central processing unit and controllable by the central processing unit to charge a battery, a power indicator unit electrically connected to the central processing unit to indicate the volume of charging power during a charging action of the charging unit, a voltage converter electrically connected to the charging unit, a memory electrically connected to the central processing unit for storing data, a signal switch electrically connected to the central processing unit, and a control chip electrically connected to the signal switch. The connection interface is electrically connected to the central processing unit of the data storage device and the control chip, and accessible to the memory through the central processing unit. The adapter interface is electrically coupled to the voltage converter and the signal switch of the data storage device for the connection of a mobile electronic device. Further, the adapter interface is electrically connectable to the control chip of the data storage device through the signal switch.

### BRIEF DESCRIPTION OF THE DRAWINGS

FIG. 1 is an elevational view of a mobile storage device in accordance with a first embodiment of the present invention.

FIG. 2 is a circuit block diagram of the mobile storage device in accordance with the present invention.

### DETAILED DESCRIPTION OF THE PREFERRED EMBODIMENT

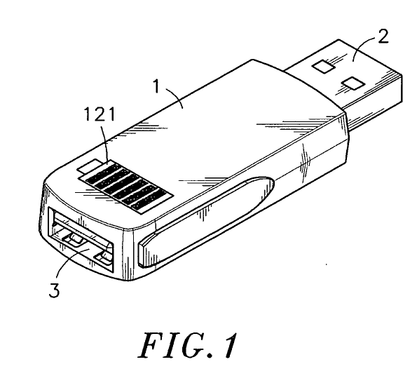

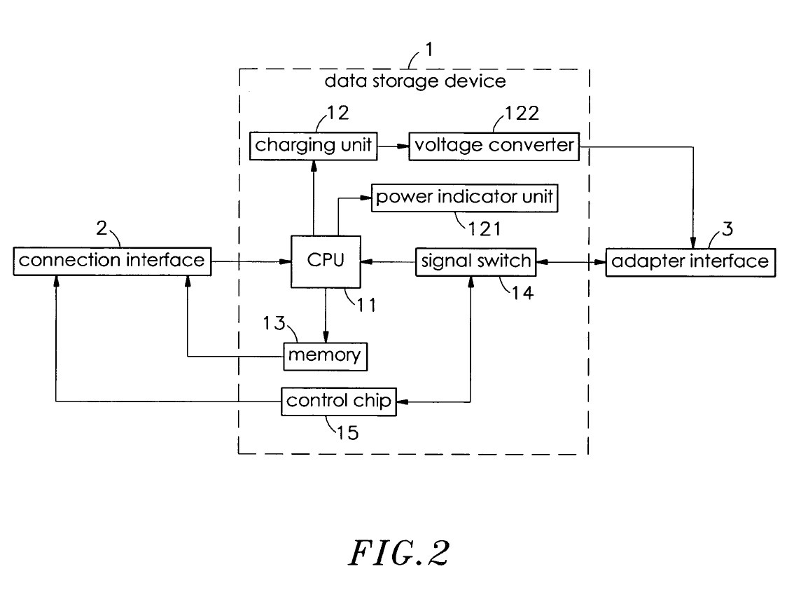

Referring to FIGS. 1 and 2, a mobile storage device is shown comprised of a data storage device 1, a connection interface 2 and an adapter interface 3.

The data storage device 1 comprises a CPU (central processing unit) 11, a charging unit 12, a power indicator unit 121, a memory 13, a signal switch 14 and a control chip 15. The power indicator unit 12, the power indicator unit 121, the memory 13 and the signal switch 14 are respectively electrically coupled to the CPU 11. The charging unit 12 can be comprised of a rechargeable battery, having electrically coupled thereto a voltage converter 122. The control chip 15 is electrically coupled to the signal switch 14. The power indicator unit 121 can be comprised of a LED display device or LCD display device

The connection interface 2 is electrically coupled to the CPU 11 of the data storage device 1, and accessible to the memory 13 through the CPU 11. The memory 13 and the control chip 15 are respectively electrically coupled to the connection interface 2.

The adapter interface 3 is electrically coupled to the voltage converter 122 and the signal switch 14 of the data storage device 1, and electrically connectable to the control chip 15 of the data storage device 1 through the signal switch 14.

The data storage device 1 can be a memory stick, mobile hard disk or any of a variety of MP3/MP4 compatible data storage means. By means of the connection interface 2, the data storage device 1 is electrically connectable to an external electronic apparatus (personal computer, notebook computer, PDA or the like) so that the CPU 11 can fetch storage data from the external electronic apparatus through the connection interface 2 and store it in the memory 13, or fetch storage data from the memory 13 and transfer it to the external electronic apparatus through the connection interface 2. By means of the operation of the CPU 11 and the signal switch 14, storage data can be transferred between the external electronic apparatus to which the connection interface 2 is connected and a mobile electronic device that is electrically connected to the adapter interface 3.

After connection of the connection interface 2 to an external electronic apparatus, the external electronic apparatus is electrically connected to the charging unit 12 through the CPU 11 to charge the data storage device 1, and at the same time the power indicator unit 121 indicates the charging volume of the battery of the data storage device 1. When a mobile electronic device (cell phone, digital camera, memory stick or MP3/MP4 player) is connected to the adapter interface 3, the charging unit 12 is electrically connected to the mobile electronic device through the voltage converter 122 and the adapter interface 3 to charge the battery of the mobile electronic device. During charging, the power indicator unit 121 indicates the charging volume of the battery of the mobile electronic device.

By means of the connection interface 2 and the adapter interface 3 subject to the control of the signal switch 14 and the control chip 15, the mobile storage device allows exchange of storage data between the external electronic apparatus and the mobile electronic device. Further, the connection interface 2 and the adapter interface 3 each can be a USB connector, IEEE 1394, RS232 or PS/2 signal interface.

As stated above, the mobile storage device of the present invention is comprised of a data storage device 1, a connection interface 2 and an adapter interface 3. When the connection interface 2 is connected to an external electronic apparatus, the external electronic apparatus can charge the battery of the data storage device 1, fetch storage data from the data storage device 1 or store data in the data storage device 1. Further, a mobile electronic device can be connected to the adapter interface 3 of the mobile storage device, for enabling the external electronic apparatus to which the connection interface 2 is connected to charge the battery of the mobile electronic device, to fetch data from the memory of the mobile electronic device, or to store data in the memory of the mobile electronic device.

As described above, the mobile storage device of the present invention has the features and advantages as follows:

1. By means of the connection interface 2 and the adapter interface 3, the mobile storage device can directly electrically connect a mobile electronic device to an external electronic apparatus without a cable, allowing data transmission between the mobile electronic device and the external electronic apparatus.

2. After connection of the connection interface 2 to an external electronic apparatus and connection of a mobile electronic device to the adapter interface 3, the external electronic apparatus can charge the battery of the mobile electronic device through the charging unit 12 and the voltage converter 122 subject to the control of the signal switch 14 and the control chip 15 without using any signal line or battery charger.

3. The connection interface 2 and the adapter interface 3 can be made subject to different format (USB, RS232, IEEE 1394, PS2) so that the mobile storage device allows connection between different electronic apparatus.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A mobile storage device comprising:
a data storage device, said data storage device comprising a central processing unit, a charging unit electrically connected to said central processing unit and controllable by said central processing unit to charge a battery, a power indicator unit electrically connected to said central processing unit to indicate the volume of charging power during a charging action of said charging unit, a voltage converter electrically connected to said charging unit, a memory electrically connected to said central processing unit for storing data, a signal switch electrically connected to said central processing unit, and a control chip electrically connected to said signal switch;
a connection interface electrically connectable to an external electronic apparatus, said connection interface being electrically connected to said central processing unit of said data storage device and said control chip and accessible to said memory through said central processing unit; and
an adapter interface electrically coupled to said voltage converter and said signal switch of said data storage device for the connection of a mobile electronic device, said adapter interface being electrically connectable to said control chip of said data storage device through said signal switch.

2. The mobile storage device as claimed in claim 1, wherein said central processing unit is a single-chip microprocessor.

3. The mobile storage device as claimed in claim 1, wherein said charging unit is a rechargeable battery.

4. The mobile storage device as claimed in claim 1, wherein said power indicator unit is comprised of a LED display device.

5. The mobile storage device as claimed in claim 1, wherein said power indicator unit is comprised of a LCD display device.

6. The mobile storage device as claimed in claim 1, wherein said memory is a read/write memory.

7. The mobile storage device as claimed in claim 1, wherein said connection interface is one of USB, IEE 1394, RS232 and PS/2 compatible interfaces.

8. The mobile storage device as claimed in claim 1, wherein said adapter interface is one of USB, IEE 1394, RS232 and PS/2 compatible interfaces.

9. The mobile storage device as claimed in claim 1, wherein said adapter interface is electrically connected to said connection interface subject to the control of said signal switch and said control chip.
